(19) United States
(12) Patent Application Publication
(10) Pub. No.: US 2004/0128623 A1
(43) Pub. Date: Jul. 1, 2004

(54) System and method for producing a patent specification and patent application

(76) Inventor: Peter David Hudson, Alton (GB)

Correspondence Address: FITCH EVEN TABIN AND FLANNERY, 120 SOUTH LA SALLE STREET, SUITE 1600, CHICAGO, IL, 60603-3406, US

(21) Appl. No.: 10/330,038

(22) Filed: Dec. 26, 2002

(51) Int. Cl. G06F 15/00

(52) U.S. Cl. 715/530

(57) ABSTRACT

A system and method for producing a patent specification has a form (100) with fields (110-180) for acquiring descriptions of different pieces of information concerning an invention. Respective portions of the acquired information are concatenated with predetermined text to form a prototype patent specification, which can be reviewed and revised as necessary by a patent attorney in order to produce a patent application for patent office filing. The form may be displayed on an internet website, the information may be transmitted over the internet and the prototype patent specification can be produced automatically. As part of this process a patent application form can also be produced automatically. This provides the following advantages: automation of a significant part of the process enables a patent specification/application to be prepared in less time, allowing the cost to be reduced and the cycle time for filing to be reduced; conversely, in view of the limited number of patent attorneys, automation of a significant part of the process enables a patent attorney to concentrate his/her time on those parts of the patent application where he/she can most efficiently apply his/her professional skills and add most value, allowing a greater number of patent applications to be prepared.

### FIELD OF THE INVENTION

This invention relates to the production of patent specifications and patent applications.

### BACKGROUND OF THE INVENTION

In the field of this invention it is known that a patent attorney writes a patent specification after discussion with an inventor.

It is known to perform this function by the inventor meeting with the patent attorney. The patent attorney will question the inventor to ensure that the patent attorney understands the invention, the technical means for carrying out the invention, and the prior art relating to the invention. The patent attorney will subsequently prepare the patent specification.

However, this approach has the disadvantage(s) that it is very time-intensive for both the inventor and the patent attorney (whose professional time is expensive), and the meeting must be arranged in advance for a mutually convenient date, adding to the total time taken. Also, a single meeting may not be sufficient for the inventor to provide to the patent attorney all the information necessary for preparation of the patent specification, necessitating further communications and/or meetings which add further to the filing delay. The total time taken to prepare and subsequently to file the patent specification complete with drawings and application forms as a patent application affects the overall cost of the process, and is also extremely important because the filing date of the patent application determines (i) which public activities (all those before the filing date) are effective against the validity of a patent granted on the patent application, and (ii) entitlement to a patent in the event of a conflict between different applicants (since the earliest to file will be entitled to the patent). Thus, even a day's delay in filing a patent application could prove fatal to securing patent protection for the invention.

Further, in view of (i) the rapidly expanding awareness of, and desire to obtain, patents, and (ii) the limited number of patent attorneys available (particularly in rapidly growing areas of technology such as cellular communications and internet techniques), the need for a patent attorney to be intensively involved in every aspect of preparing the patent specification is inefficient.

It is an object of the present invention to provide a system and method for producing a patent specification and patent application wherein the abovementioned disadvantage(s) may be alleviated.

### STATEMENT OF INVENTION

In accordance with a first aspect of the present invention there is provided a system for producing a claim for a patent specification as claimed in claim 1.

In accordance with a second aspect of the present invention there is provided a system for producing a patent specification as claimed in claim 7.

In accordance with a third aspect of the present invention there is provided a system for producing a patent specification for an invention as claimed in claim 17.

In accordance with a fourth aspect of the present invention there is provided a system for producing a document for a patent application as claimed in claim 18.

In accordance with a fifth aspect of the present invention there is provided a system for producing a patent application as claimed in claim 22.

In accordance with a sixth aspect of the present invention there is provided a method for producing a claim for a patent specification for an invention as claimed in claim 23.

In accordance with a seventh aspect of the present invention there is provided a method for producing a patent specification as claimed in claim 29.

In accordance with an eighth aspect of the present invention there is provided a method for producing a patent specification for an invention as claimed in claim 39.

In accordance with a ninth aspect of the present invention there is provided a method for producing a document for a patent application as claimed in claim 40.

In accordance with a tenth aspect of the present invention there is provided a method for producing a patent application as claimed in claim 44.

In accordance with an eleventh aspect of the present invention there is provided a patent application for an invention as claimed in claim 45.

### BRIEF DESCRIPTION OF THE DRAWING(S)

One system and method for producing a patent specification and patent application incorporating the present invention will now be described, by way of example only, with reference to the accompanying drawing(s), in which:

FIG. 1 shows an internet website form used in producing a patent specification;

FIG. 2 shows a further internet website form used in producing an application form for a patent application; and

FIGS. 3-10 show pages of a patent application produced using the present invention.

### DESCRIPTION OF THE PREFERRED EMBODIMENT

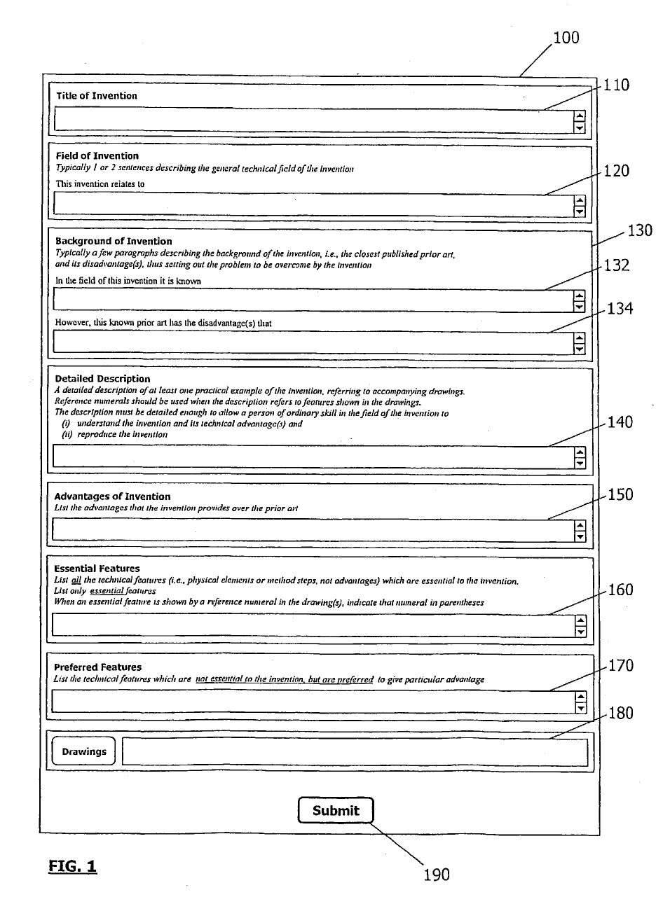

Referring to FIG. 1, a form 100 is displayed on an internet website page which may be viewed via a standard browser program such as ‘Internet Explorer’ by Microsoft, Inc. or ‘Netscape Navigator’ by Netscape, Inc. As will be explained in greater detail below, the form contains a number of fields for entry and submission of information, and in order to maintain security of this information during transfer across the internet the form 100 is made accessible at the internet website using secure hypertext transfer protocol (HTTPS) secure socket layer (SSL) encryption, as is well known.

The form 100 has a number of fields 110, 120, 130, 140, 150, 160, 170 and 180 for entry of information. As will be explained in greater detail below, the field indicated generally as 130 is comprised of two individual fields 132 and 134. Fixed text is displayed before each of these fields respectively to describe the respective fields and to indicate the type of information to be entered in the respective fields. Although as shown in the drawing all the fields have the same size, in practice the size of some of the fields (particularly, for example, fields 140 and 160) will typically be increased so as to allow more of the field text to be viewed simultaneously. Moreover, the fields are, in fact, scrollable by the ‘up/down’ arrows shown at the fields' right side to allow large amounts of text to be inserted as may be required

An inventor wishing to submit his/her invention for preparation of a patent specification uses, for example, a browser program to view the form 100 on the internet website page, and enters information about different areas of the invention into the form fields as follows.

In the field 110 headed “Title of Invention”, the inventor enters text information of his/her invention's title.

In the field 120 headed “Field of Invention”, the inventor follows the explanatory text “Typically 1 or 2 sentences describing the general technical field of the invention” and “This invention relates to” and enters text information describing the field of his/her invention.

In the field 130 headed “Background of Invention”, the inventor follows the explanatory text “Typically a few paragraphs describing the background of the invention, i.e., the closest published prior art, and its disadvantage(s), thus setting out the problem to be overcome by the invention” and enters text information describing the background of his/her invention. In particular:

in the field 132 the inventor follows the introductory text “In the field of this invention it is known” and enters text information describing what is known from the prior art in the field of his/her invention; and

in the field 134 the inventor follows the introductory text “However, this known prior art has the disadvantage(s) that” and enters text information describing the disadvantage(s) of the known prior art described in the field 132.

In the field 140 headed “Detailed Description”, the inventor follows the explanatory text “A detailed description of at least one practical example of the invention, referring to accompanying drawings. Reference numerals should be used when the description refers to features shown in the drawings. The description must be detailed enough to allow a person of ordinary skill in the field of the invention to (i) understand the invention and its technical advantage(s) and (ii) reproduce the invention” and enters text information describing in detail one or more practical examples of his/her invention.

In the field 150 headed “Advantages of Invention”, the inventor follows the explanatory text “List the advantages that the invention provides over the prior art” and enters text information describing the advantages of his/her invention.

In the field 160 headed “Essential Features”, the inventor follows the explanatory text “List all the technical features (i.e., physical elements and/or method steps, not advantages) which are essential to the invention”, “List only essential features” and “When an essential feature is shown by a reference numeral in the drawing(s), indicate that numeral in parentheses” and enters text information describing the essential features of his/her invention.

In the field 170 headed “Preferred Features”, the inventor follows the explanatory text “List the technical features which are not essential to the invention, but are preferred to give particular advantage” and enters text information describing the preferred features of his/her invention.

In the field 180 headed “Drawings”, the inventor enters a link to an electronic file containing one or more drawings to accompany the detailed description entered in the field 160. The drawing file may be in any convenient format (such as, for example, prepared in a computer drawing program and saved as a vector-based image, or drawn manually and scanned to produce an electronic file in the form of a bit-map image).

When all of the appropriate information has been entered into the fields 110-180, the inventor ‘presses’ (i.e., clicks on with a button of a pointing device such as a mouse) the ‘Submit’ button 190 to submit the entered information via secure internet transfer to the internet website holding the page 100.

From the website, a patent attorney retrieves the inventor's submitted information, and processes it (as will be described below) to produce a prototype patent specification. In order to generate the prototype patent specification, the patent attorney passes the inventor's submitted information into a computer database (in this example a database in the computer program ‘FileMaker Pro’ by Claris, Inc., but any other suitable computer database program could alternatively be used), each field of the submitted information being passed into a respective field in the same record in the database. The information submitted in the form 100 may conveniently be passed to the ‘FileMaker Pro’ database by utilising the program's ‘import’ function; other database programs typically have the same or similar function.

The database contains for each record a further field which combines the information from the other fields of the record according to the following formula:

Upper(Trim(Field_{—}1))□&□“¶¶¶Field□of□the□Invention¶¶This□invention □relates□to□”□&□Trim(Field□2)□&□If(Right(Trim(Field□2), 1)=“.”,“”,“.”)□&□“¶¶¶Background□of□the□Invention¶¶In□the□field□of□this□invention□it□is□known□”□&□Trim(Field□3)□&□If (Right(Trim(Field□3),1)=“.”,“”,“.”)□&□“¶¶However,□this□known □prior□art□has□the□disadvantage(s)□that□”□&□Trim(Field□4)□& □If(Right(Trim(Field□4),1)=“.”,“”,“.”)□&□“¶¶It□is□an□object □of□the□present□invention□to□provide□”□&□Lower(Trim(Field□1)) □&□“□wherein□the□abovementioned□disadvantage(s)□may□be□alleviated.”□&□“¶¶¶Statement□of□Invention¶¶In□accordance□with □the□present□invention□there□is□provided□”□&□Lower(Trim(Field□1)) □&□“□as□claimed□in□claim□1.¶¶¶Brief□Description□of□the □Drawing(s)¶¶One□”□&□Lower(Trim(Field□1))□&□“□incorporating □the□present□invention□will□now□be□described,□by□way□of□example □only,□with□reference□to□the□accompanying□drawing(s),□in□which:¶FIG.□1□shows”□&□“¶¶¶Description□of□Preferred□Embodiment¶¶”□&∇Trim(Field□5)□&□If(Right(Trim(Field□5),1)=“.”, “”,“.”)□&□“¶¶It□will□be□understood□that□the□”□&□Lower(Trim (Field□1))□&□“□described□above□provides□the□following□advantages:¶”□&□Trim(Field□6)□&□If(Right(Trim(Field□6),1)=“.”,“”,“.”) □&□“¶¶¶Claims¶¶1.□□A□”□&□Lower(Trim(Field□1))□&□“,□comprising:¶”□&□Trim(Field□7)□&□If(□Right(Trim(Field□7),1)=“.”,“”,“.”) □&□“¶¶2.□□The□”□&□Lower(Trim(Field□1))□&□“□according□to□claim□1,□further□characterised□by:¶”□&□Trim(Field□8)□&□If(Right(Trim(Field□8),1)=“.”,“”,“.”)□&□“¶¶3.□□A□”□&□Lower (Trim(Field□1))□&□“substantially□as□hereinbefore□described□with□reference□to□the□accompanying□drawing(Is).¶¶¶Abstract¶¶”m □&□Upper(Field□1)□&□□“¶¶A□”□&□Lower(Trim(Field□1))□&□“□having □”□&□Trim(Field□7)□&□If(Right(Trim(Field□7),1)=“.”,“”,“.”0 □&□“¶This□provides□the□following□advantage(s):¶”□&□Trim(Field□6) □&□If(Right(Trim(Field□6),1)=“.”,“”,“.”)□&□“¶¶”□&□Field□9

where ‘Field□1’ corresponds to the field 110 of the form 100, ‘Field□2’ corresponds to the form field 120, ‘Field□3’ corresponds to the form field 132, ‘Field□4’ corresponds to the form field 134, ‘Field□5’ corresponds to the form field 140, ‘Field□6’ corresponds to the form field 150, ‘Field□7’ corresponds to the form field 160, ‘Field□8’ corresponds to the form field 170, ‘Field□9’ corresponds to the form field 180, the ‘Trim( )’ function serves to remove any trailing spaces from text, the ‘Upper( )’ function serves to convert text to upper case form, the ‘Lower( ) ’ function serves to convert text to lower case form, the “If(Right( . . . ))’ function serves to insert a final “.” character (if not already present) to text, ‘&’ serves to concatenate text, pairs of ‘″’ characters enclose literal text, ‘¶’ represents a carriage-return and ‘□’ represents a space.

As will be described in greater detail below, this formula generates and places in the composite database field a string of text (and a link to the drawing file) which contains a succession of sections (complete with section headings such as ‘Field of the Invention’, etc.) formed from the information submitted in the respective fields of the website form 100, and which together constitute a prototype patent specification.

In particular, it will be understood that the section of the formula

“Claim¶¶1.□□A□”□&□Lower(Trim(Field□1))□&□“,□comprising:¶”□& □Trim(Field□7)□&□If(□Right(Trim(Field□7),1)=“.”,“”,“.”)□&□“¶¶2.□□The□”□&□Lower(Trim(Field□1))□&□“□according□to□claim□1, □further□characterised□by:¶”□&□Trim(Field□8(□&□If(Right(Trim (Field□8),1)=“.”,“”,“.”)□&□“¶¶3.□A□”□&□Lower(Trim(Field□1))□&□“□substantially□as□hereinbefore□described□with□reference □to□the□accompanying□drawing(s).”

generates a string with the heading “Claims”, followed by two carriage-returns, and followed by three patent claims formed as follows:

firstly, an independent claim beginning with the text “1. A ”, a lower case version of the ‘title’ information submitted in the website form field 110, the text “, comprising:”, a carriage-return, and then a version of the ‘essential features’ information submitted in the website form field 160, and finally a concluding “.” character (if not already present) and two carriage-returns;

secondly, a dependent claim beginning with the text “2. The”, a lower case version of the ‘title’ information submitted in the website form field 110, the text “according to claim 1, further characterised by:”, a carriage-return, and then a version of the ‘preferred features’ information submitted in the website form field 170, and finally a concluding “.” character (if not already present) and two carriage-returns; and

thirdly, an independent ‘omnibus’ claim beginning with the text “3. A”, a lower case version of the ‘title’ information submitted in the website form field 110, and the text “substantially as hereinbefore described with reference to the accompanying drawing(s).”.

Also, it will be understood that the section of the formula

“Abstract¶¶”∇&□Upper(Field□1)□&□□“¶¶A□”□&□Lower(Trim(Field□1)) □&□“□having□”□&□Trim(Field□7)□&□If(Right(Trim(Field□7), 1)=“.”,“”,“.”)□&□“¶This□provides□the□following□advantage(s):¶”□&□Trim(Field□6)□&□If(Right(Trim(Field□6),1)=“.”“”,“.”)”

generates a string with the heading “Abstract”, followed by two carriage-returns, followed by an upper case version of the ‘title’ information submitted in the website form field 110, followed by two carriage-return is, followed by a patent abstract beginning with the text “A”, a lower case version of the ‘title’ information submitted in the website form field 110, the text “having”, then a version of the ‘essential features’ information submitted in the website form field 160, and finally a concluding “.” character (if not already present). The abstract so formed continues with a carriage-return, followed by the text “This provides the following advantage(s):”, another carriage-return, then a version of the ‘advantages’ information submitted in the website form field 150, and finally a concluding “.” character (if not already present). It will be appreciated that such an abstract complies at least with the requirements of Rule 33(1)-(3) & 33(5) of the European Patent Convention. It will further be appreciated that since such an abstract will include (as indicated in the explanatory text of the website form field 160) parenthesised reference numerals, it will also comply with the requirements of Rule 33(4) of the European Patent Convention.

It will be further understood that the remainder of the formula (i.e., the portion before the claims and abstract sections described above) generates a string comprising the body of a patent specification, with sections “Field of Invention”, “Background of Invention”, “Statement of Invention”, “Brief Description of the Drawing(s)” and “Description of Preferred Embodiment”, incorporating information from the form fields 110, 120, 130, 140 and 150.

The patent attorney then copies the contents of this composite database field to the computer's ‘clipboard’ and opens a ‘blank’ word-processing document template (in this example a document in the popular word-processing computer program ‘Word’ by Microsoft, Inc, although another word-processing program could alternatively be used). This series of operations (selecting, copying-to-clipboard and opening the word-processing document) may conveniently be stored in a single macro (which in ‘FileMaker Pro’ is called a ‘script’) in ‘FileMaker Pro’ and this script may be run either by selecting it from a menu or (even more conveniently) by assigning the script to a button (e.g., labelled ‘Transfer’) which when ‘pressed’ runs the script and performs the series of operations.

The patent attorney then ‘pastes’ the clipboard contents (i.e., the contents of the composite database field) into the blank ‘Word’ template document. The ‘Word’ template document may contain fixed text and images (as will be described below), and is pre-formatted so as to conform to the common formal requirements of a patent application in most major patent office jurisdictions, e.g.: page size being set to A4 in portrait mode in compliance with European Patent Convention (EPC) Rule 35(4), pages having a left margin of 1.5″, a right margin of 1″, a top margin of 1″ and a bottom margin of 1″ in compliance with EPC Rule 35(6), and lines of text being numbered (in the aforementioned left margin, so as to leave a blank left margin of a little over 2.5 cm) in increments of 5 starting on each page in compliance with EPC Rule 35(9), and having a page header in which an automatically-incrementing Arabic-numeral page number is centred (so as to leave a blank top margin of a little over 2 cm) in compliance with EPC Rule 35(8).

With the composite form field information pasted from the ‘clipboard’ into the ‘Word’ document, the patent attorney then finds the word “Claims” in the document indicating the beginning of the ‘claim’ section and inserts a ‘page break’ immediately before this word, to comply with EPC Rule 35(5). Similarly, the patent attorney finds the word “Abstract” in the document indicating the beginning of the ‘abstract’ section and inserts a ‘page break’ immediately before this word, also to comply with EPC Rule 35(5). Finally, the patent attorney formats the whole document to a 12-point font such as ‘courier’, with line spacing of 1.5 lines. It will be understood that these searches for “Claims” and “Abstract” and the consequent ‘page break’ insertions, together with the final formatting, may conveniently be performed from a ‘macro’ which (similarly to the ‘FileMaker Pro’ script described above) holds the instructions for performing these steps. It will further be understood that, for added convenience if desired, the macro could also automatically find each of the section headings (e.g., “Field of the Invention”, “Claims”, etc.) and apply to each of these headings a format such as ‘bold’, ‘underline’ or any other desired format (such as keeping these headings respectively on the same pages as their immediately subsequent text to aid legibility).

It still further be understood that the initial ‘paste from clipboard’ operation described above may be conveniently arranged to be performed as part of the same macro as the initial operation in the “search” and “insert” macro described in the immediately preceding paragraph, and that this macro can conveniently be arranged to run automatically when the word-processing document is opened, thus reducing the patent attorney's actions to simply running the script described above in ‘FileMaker Pro’ (which may be done, as described, by ‘pressing’ a ‘button’ in the database), the rest of the process then occurring automatically within the ‘FileMaker Pro’ script and then automatically within the word-processing document macro.

It will be understood that the resultant automatically-generated ‘Word’ document contains a prototype patent specification, complying with relevant formal requirements and with appropriate sections (‘Title’, ‘Field of Invention’, Background of Invention’, ‘Statement of Invention’, ‘Brief Description of Drawing(s)’, ‘Description of Preferred Embodiment’, ‘Claims’ and ‘Abstract’) which together contain all the necessary information in appropriate form for filing (with an appropriate application form—which, as will be described hereafter, is typically conveniently generated automatically from information submitted in the same way as the invention information described above—and drawings) as a patent application.

It will be understood that the drawing file submitted in the website form field 180 may be inserted as a picture image(s) on a final page(s) of the patent specification generated above, or may be processed separately (such as by being separately printed out and physically attached to a printed copy of the generated patent specification).

If the patent attorney already knows the applicant/inventor details which are necessary for completing the patent application form (for example, in the case of an invention submitted for United Kingdom patent filmngr bv an inventor on behalf of his/her employer with whom the patent attorney has an arrangement to prepare patent applications, the patent attorney may already know all the necessary information such as the name and address of the applicant for the patent, and whether there will be a requirement for filing; a supporting statement of inventorship and of right to grant of a patent), no further information will be required in order to generate the U.K. patent application form (Patents Form 1/77). However, more typically in other cases such applicant/inventor details will not already be known to the patent attorney, and so must be obtained from the inventor.

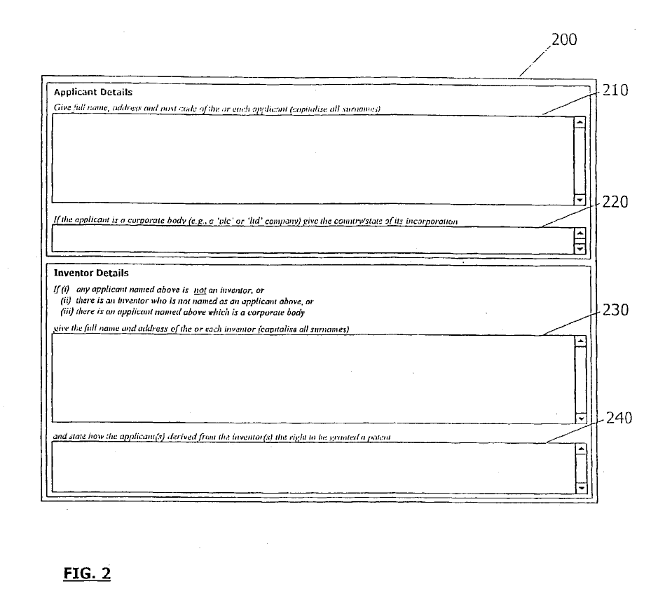

Referring now to FIG. 2, in order to obtain the necessary applicant/inventor details, a form 200 is displayed to the inventor on the same website page as the form 100 described above. The form 200 may be conveniently be part of the form 100 (and the information entered in the form fields 210-240 may be conveniently transferred to the patent attorney at the same time as the information in the form fields 110-190 as described above), but for the purposes of illustrational simplicity the form 200 is shown separately. Like the form 100 described above, the form 200 contains a number of fields for entry and submission of information securely using HTTPS/SSL techniques.

The form 200 has a number of fields 210, 220, 230, 240 for entry of detailed information relating to the applicant/inventor. If necessary, the inventor submits applicant/inventor details in the form 200 as follows.

In the field 210 headed “Applicant Details”, the inventor follows the explanatory text “Give full name, address and post code of the or each applicant (underline all surnames)” and enters the relevant details of the applicant(s). If appropriate, in the field 220 the inventor follows the explanatory text “If the applicant is a corporate body (e g., a ‘plc’ or ‘ltd’ company) give the country/state of its incorporation” and enters the applicant's country/state of incorporation.

In the field 230 headed “Inventor Details”, the inventor follows the explanatory text “If (i) any applicant named above is not an inventor, or (ii) there is an inventor who is not named as an applicant above, or (iii) there is an applicant named above which is a corporate body, give the full name and address of the or each inventor (underline all surnames)” and if appropriate the inventor enters the relevant details of the inventor(s). If appropriate, in the field 240 the inventor further follows the explanatory text “and state how the applicant(s) derived from the inventor(s) the right to be granted a patent” and enters the relevant details of how the prima facie right of the inventor(s) passed to the applicant(s).

It will be understood that with the form 200 being part of the form website form 100 described above, the information entered into the fields 210-240 of the form 200 will be transferred to the patent attorney and will be imported by the patent attorney into relevant fields in the ‘FileMaker Pro’ database together with the information from the other fields from the website form field 100 as described above. It will further be understood that the information entered into the fields 210-240 of the form 200 will be incorporated in the composite database field described above by inserting into the formula discussed above for the composite database field (at the point immediately before the final ‘Field□9’) the following:

Applicant□Name/Address¶“□&□Trim(Field□10)□&□”¶¶¶Applicant□Incorporation¶“□&□Trim(Field□11)□&□”¶Inventor□Name/Address¶”□&□Trim(Field□12)□&□“¶¶¶Applicant□Right¶”□&□Trim(Field□13) □&□” “¶¶¶YesNo¶”Field□14

where ‘Field□10’ corresponds to the field 210 of the form 200, ‘Field□11’ corresponds to the form field 220, ‘Field□12’ corresponds to the form field 230, ‘Field□13’ corresponds to the form field 240. As will be discussed in greater detail below, ‘Field□14’ is itself a calculation field having the formula:

If(Trim(Field□12)=“”, “No”, “Yes”).

As will be described in greater detail below, this addition to the formula of the composite database field generates and places in the composite database field a string of text (before the link to the drawing file) which contains five additional sections formed from the applicant/inventor detailed information submitted in the respective fields 210-240 of the website form 200, and which are used to complete the patent application form to accompany the automatically generated patent specification described above.

In particular, it will be understood that the section of the formula

“Applicant□Name/Address¶″□&□Trim(Field□10)”

generates a string with the heading “Applicant Name/Address”, followed by a carriage-return, and followed by the information about the applicant's name and address submitted in the website form field 210.

Also, it will be understood that the section of the formula

“Applicant□Incorporation¶″□&□Trim(Field□11)”

generates a string with the heading “Applicant Incorporation”, followed by a carriage-return, and followed by the information about the applicant's country/state of incorporation submitted in the website form field 220.

Further, it will be understood that the section of the formula

“Inventor□name/Address¶″□&□Trim(Field□12)”

generates a string with the heading “Inventor Name/Address”, followed by a carriage-return, and followed by the information about the name and address of the inventor(s) submitted in the website form field 230.

Further, it will be understood that the section of the formula

“Applicant□Right¶″□&□Trim(Field□13)”

generates a string with the heading “Applicant Right”, followed by a carriage-return, and followed by the information about the applicant's right to the patent submitted in the website form field 240.

Finally, it will be understood that the section of the formula

“″YesNo¶″Field□14”

generates a stringy with the heading “YesNo”, followed by a carriage-return, and followed by either “Yes” if the website form field 230 contains text (apart from space characters) indicating that inventor name/address information is present in this field, or “No” if the website form field 230 contains no text (apart from space characters) indicating that no inventor name/address information is present in this field.

It will further be understood that when the patent attorney ‘copies’ the contents of the clipboard containing these additional five sections and the other information described above and ‘pastes’ the information into the blank ‘Word’ document, the applicant/inventor information is transferred into the ‘Word’ template document.

In order to utilise this additional information, the ‘Word’ template document additionally contains (in additional to the formatting and layout parameters described above) two pages containing respectively background images of the two sheets of the U.K. patent office application form 1/77. On these two pages the ‘Word’ document has:

a ‘field code’ named “APPLICANTNAMEADDRESS” at a position corresponding to the background image of form 1/77 at the part of section 3 thereof requiring insertion of the applicant's name and address;

a ‘field code’ named “APPLICANTINCORPORATION” at a position corresponding to the background image of form 1/77 at the part of section 3 thereof requiring insertion of the applicant's state/country of incorporation; and

a ‘field code’ named “YESNO” at a position corresponding to the background image of form 1/77 at section 8 thereof requiring an indication of whether a statement is required in support of the applicant's right to the patent.

Also, as will be described in greater detail below, the ‘Word’ template document also has additional field codes as follows:

a ‘field code’ named “APPLICATIONTITLE” at a position corresponding to the background image of form 1/77 at section 4 thereof requiring insertion of the title of the patent application;

a ‘field code’ named “DESCRIPTIONPAGES” at a position corresponding to the background image of form 1/77 at the part of section 9 thereof requiring insertion of the total number of pages of description in the patent application;

a ‘field code’ named “CLAIMPAGES” at a position corresponding to the background image of form 1/77 at the part of section 9 thereof requiring insertion of the total number of pages of claims in the patent application;

a ‘field code’ named “ABSTRACTPAGES” at a position corresponding to the background image of form 1/77 at the part of section 9 thereof requiring insertion of the total number of pages of abstract in the patent application; and

a ‘field code’ named “DRAWINGPAGES” at a position corresponding to the background image of form 1/77 at the part of section 9 thereof requiring insertion of the total number of pages of drawings in the patent application.

Finally, the ‘Word’ document is provided with the following fixed text:

the patent attorney's name and address at a position corresponding to the background image of form 1/77 at section 5 thereof; and

the patent attorney's contact name and telephone number at a position corresponding to the background image of form 1/77 at section 12 thereof.

Further, if desired, a ‘field code’ for automatically inserting the current date may be provided at a position corresponding to the background image of form 1/77 at the relevant part of section 11 thereof. Also, if desired, a ‘field code’ for automatically inserting a reference number (which may, for example, be a combination of the patent attorney's initials and a unique number based on the date and time) may be provided at a position corresponding to the background image of form 1/77 at section 1 thereof.

In order to insert the relevant information into the form 1/77, the patent attorney performs the following steps in addition to those described above.

The patent attorney searches for the text “Applicant Name/Address”, which begins the first of the additional sections of detailed applicant/inventor information, and selects the text of the remainder of this section (without the above section heading), then inserts a ‘bookmark’ with the name “APPLICANTNAMEADDRESS” for the selected text.

The patent attorney next searches for the text “Applicant Incorporation”, which begins the second of the additional sections of detailed applicant/inventor information, and selects the text of the remainder of this section (without the above section heading), then inserts a ‘bookmark’ with the name “APPLICANTINCORPORATION” for the selected text.

The patent attorney next searches for the text “YesNo”, which begins the fifth of the additional sections of detailed applicant/inventor information, and selects the text of the remainder of this section (without the above section heading), then inserts a ‘bookmark’ with the name “YESNO” for the selected text.

The patent attorney then searches again for the text “Applicant Name/Address” which begins the first of the additional sections of detailed applicant/inventor information, then selects the text of all five of these additional sections, and finally applies the formatting property ‘hidden’ to this selected text so that these additional sections will not ordinarily appear when the document is printed.

The patent attorney then moves to the start of the document, views the ‘Header and Footer’ portion of this section for editing and inserts into this portion a ‘field code’ named “SectionPages” which automatically inserts the number of pages in this section. The patent attorney then selects this field code and inserts a ‘bookmark’ named “DESCRIPTIONPAGES” for this selected text. Finally, the patent attorney applies to the selected text the formatting property ‘hidden’ so that it will not ordinarily appear when the document is printed.

The patent attorney then searches for the text “\hat{ }mClaims” (‘\hat{ }m’ indicating a manual page break which was inserted before the claims section above), and replaces this found text with “\hat{ }bClaims” (‘\hat{ }b’ indicating a section break). With insertion point in the claims section, the patent attorney then views the “Header and Footer” portion of this section for editing, ensures that the header/footer of this section is not the same as that of the previous section, and inserts into this portion a ‘field code’ named “SectionPages” which automatically inserts the number of pages in this section. The patent attorney then selects this field code and inserts a ‘bookmark’ named “CLAIMPAGES” for this selected text. Finally, the patent attorney applies to the selected text the formatting property ‘hidden’ so that it will not ordinarily appear when the document is printed.

The patent attorney then searches for the text “\hat{ }mAbstract” (‘\hat{ }m’ indicating a manual page break which was inserted before the abstract section above), and replaces this found text with “\hat{ }bAbstract” (‘\hat{ }b’ indicating a section break). With insertion point in the abstract section, the patent attorney then views the “Header and Footer” portion of this section for editing, ensures that the header/footer of this section is not the same as that of the previous section, and inserts into this portion a ‘field code’ named “SectionPages” which automatically inserts the number of pages in this section. The patent attorney then selects this field code and inserts a ‘bookmark’ named “ABSTRACTPAGES” for this selected text. Finally, the patent attorney applies to the selected text the formatting property ‘hidden’ so that it will not ordinarily appear when the document is printed.

The patent attorney finally moves to the end of the abstract section and inserts a section break (‘\hat{ }b’). In the section following the abstract, the patent attorney then views the ‘header’ portion for editing, ensures that the header of this section is not the same as that of the previous section, and inserts into this portion ‘field codes’ named “NumPages” and “SectionPages” separated by a ‘/’ character. The patent attorney then selects the ‘SectionPages’ field code and inserts a ‘bookmark’ named “DRAWINGPAGES” for this selected text. Finally. the patent attorney centers the ‘NumPages’, ‘/’ and ‘SectionPages’ characters in the header. It will be understood that the drawing images can thus be inserted, preferably as separate images on consecutive sheets in the drawings section, and that this numbering scheme in the header portion of this section will adjust its numbering automatically as new pages are inserted in the drawing section, the numbering scheme complying with the conventional standard for numbering of drawing pages.

It will be understood that the effect of the above actions is to link the ‘field codes’ already present in the ‘Word’ template document with the text inserted and bookmarked as described above, and thereby to insert into the ‘Word’ template document the relevant text at relevant positions.

It will be understood that if it is necessary to file a statement of inventorship and right to apply for the patent (U.K. patent form 7/77), this form is generated (utilising the information submitted in the website form fields 230 and 240) automatically by inserting the relevant information at appropriate positions on a copy or image of form 7/77 via linking bookmarks in the same way as that described above for the generation of the application form 1/77.

It will be understood that all of the actions described above as being performed by the patent attorney can conveniently be performed automatically within a macro in the ‘Word’ document, all of the macros described above being most conveniently consolidated in a single macro which is automatically run as the word processing template document is opened.

It will be understood that in this way not only can the patent specification be automatically generated, but the patent application form can also be generated automatically, requiring only to be signed (and possibly dated and completed with an identifying reference number) by the patent attorney. In this way, it will be appreciated that the present invention allows an entire patent application to be generated automatically and would even allow such an automatically generated application to be quickly prepared and filed (it could even be automatically sent electronically to the patent office) if it were vital for an application to be filed without delay. It will, of course, be understood that if even delay for a patent attorney to check and sign the application would be unacceptable in order for a filing deadline to be met, the automatically generated patent application could be automatically sent for filing (e.g., electronically, such as by facsimile or by using a system such as ‘epoline’ offered by the European Patent office or ‘PCT-EASY’ offered by the World Intellectual Property Organisation which provide for both electronic filing and authentication of the identity of the filer) and could serve as a provisional application to secure a filing date (being formally signed at a later date, if necessary).

Although it will be understood that such rapid preparation and filing without the opportunity for full and considered patent attorney review may have significant eventual disadvantages (since the prohibition against adding matter during prosecution of the patent application may make it be difficult or impossible to correct deficiencies present in the application as filed), in the case where a publication has already occurred earlier during a day the present invention provides a final opportunity of securing patent protection by allowing a patent application to be filed on the same day, allowing patent protection to be secured for a patentable invention that would otherwise be lost.

Typically, the prototype patent specification/application generated in this way does not require immediate filing, allowing the patent attorney time to review the automatically generated patent specification/application fully and considerately. In this case, the prototype patent specification/application generated in this way is then reviewed by the patent attorney and revised as necessary to ensure that the final patent specification reads coherently and complies with other necessary technical and legal requirements for filing a patent application, and to ensure that the scope of protection provided by the claims is optimised. For example, the patent attorney will complete the section “Brief Description of the Drawing(s)” by completing the statement “FIG. 1 shows” (and if necessary inserting similar statements for “FIG. 2” and any further figures), will ensure that the description of the preferred embodiment section provides sufficient detail to enable the invention to be practised by a person of ordinary skill in the art, and will ensure that the terminology is consistent and accurate throughout the patent specification. Also, the patent attorney will ensure that any references to “the invention” in the patent specification are consistent with the broadest aspect of the invention as set out in the claims.

In particular, the patent attorney will closely review the independent patent claim (claim 1, which as described above is constructed from the ‘title’ information and the ‘essential features’ information submitted in the relevant website form fields, together with appropriate introductory and bridging phraseology) to ensure that the terminology in the claim is appropriately broad and not unnecessarily restrictive, to ensure that all of the features recited in the claims are indeed essential to the broadest scope of the invention, and will determine whether any further features might be essential (and if so, the patent attorney will add such further essential features).

The patent attorney will also closely review the dependent claim (claim 2, which as described above is constructed from the ‘title’ information and the ‘preferred features’ information submitted in the relevant website form fields, together with appropriate introductory and bridging phraseology) and will typically also expand the number of claims by separating out some of the ‘preferred features’ from the prototype claim 2 into one or more further dependent claims. It will be understood that if desired the patent attorney may use a ‘macro’ to automatically parse the submitted text of ‘preferred features’ so as to separate out features divided by words such as “and”, “or”, etc., in order to identify features that might be separated out into different dependent claims.

The patent attorney will typically also, as appropriate, add further independent claims (and subsequent dependent claims) directed to different aspects of the invention (such as, for example, ‘device’ claims, ‘method’ claims, and ‘system’ claims). It will be understood that if desired the patent attorney may use, similarly to the process described above, a ‘macro’ to automatically parse the submitted text of ‘essential features’ so as to separate out features divided by words such as “and”, “or”, etc., in order to identify features that might be separated out into different independent claims.

If the patent application is to be filed in a jurisdiction where ‘omnibus’ claims are not permitted, the patent attorney will delete the ‘omnibus’ claim provided in the prototype patent specification as claim 3. If the ‘omnibus’ claim is to remain, the patent attorney will review (and typically revise) the numbering of this claim in view any additional claims that the patent attorney may have inserted as described above; the patent attorney will also separate out the ‘omnibus’ claim provided in the prototype patent specification into individual ‘omnibus’ claims directed to separate aspects of the invention (such as ‘method’ and ‘apparatus’ aspects similarly to the separating out of the independent claim 1 described above).

The patent attorney will also (if parenthesised reference numerals in claims are not required in the particular jurisdiction in which the patent application is to be filed) remove any parenthesised reference numerals in the claims. It will be appreciated that this search and removal may be performed manually, or if desired this search and removal may be conveniently performed in a ‘macro’, similar to that described above, which will search for parenthesised text in the part of the patent specification from the “Claims” heading to the “Abstract” heading and will replace each found occurrence of parenthesised text with a zero-length text string.

The patent attorney will finally review the abstract provided in the prototype patent specification (which, it will be appreciated, is constructed from the ‘title’ information, the ‘essential features’ information, and the ‘advantages’ information submitted in the relevant website form fields, together with appropriate introductory and bridging phraseology) to ensure that the abstract reads coherently and has a length of no more than the preferred 150 words. It will be appreciated that the patent attorney may check the word length of the abstract by using a ‘word count’ tool, and in the event that the preferred word length is exceeded may reduce the word length of the abstract by use of an ‘auto summarize’ tool, both of these tools being typically provided in modern computer word-processing programs such as ‘Word’. It will further be appreciated that if desired these ‘word count’ and conditional ‘auto summarized’ operations may be conveniently performed in a ‘macro’, similar to those described above.

It will, of course, be appreciated that although in the above description various operations are described as possibly being incorporated in ‘macros’ in the word-processing program, all of these operations may be incorporated in a single ‘macro’ in the word-processing program, which may be that which is automatically run when the ‘blank’ template document is opened.

It will also be appreciated that although in the above description the prototype patent specification is generated in two stages (the first being the generation of the text string in the composite field in the ‘FileMaker Pro’ database, and the second being the formatting and revision of this text in the word-processing document), these two stages could if desired be combined into a single stage in the word-processing program by importing the form field information directly into the word-processing program and using a ‘macro’ in the program to generate the prototype patent specification, and then carrying out the subsequent formatting and revision in the word-processing document as described above.

It will also be understood that if desired the ‘FileMaker Pro’ database itself may be ‘shared’ on the website, in which case the form 100 may be a layout in the database. In this case, the inventor will enter information directly into the database, and the patent attorney will not have to import the information as described above. Instead, the patent attorney will simply copy the contents of the composite database field (which would not be visible to the inventor) to the word-processing document and will follow the rest of the procedure (which may occur automatically) to generate the prototype patent application.

When the patent attorney has reviewed and, as necessary, revised the prototype patent specification/application generated above, the patent attorney will send (for example, by encrypted email, so as to maintain confidentiality) the final patent specification to the inventor for approval, and after approval by the inventor will file it as a patent application (together with the application form, etc.) at a national patent office or an international patent office such as the European Patent Office based in Munich or a receiving office of the World Intellectual Property Organisation for a Patent Cooperation Treaty application. For those patent offices which may allow electronic filing of patent applications, the patent attorney may conveniently file the patent application electronically.

It will be appreciated that this system for preparing a patent specification/application is well-suited to use with an internet terminal which might be based on a desktop personal computer (PC) or a portable data terminal such as an internet-enabled laptop PC, an internet-enabled personal digital assistant (PDA) or other data terminal such as for example a wireless application protocol (WAP) enabled cellular telephone. The internet terminal could be used to submit details of the invention, and the patent specification could be generated from this information as described above and (after review and possible revision by a patent attorney) transmitted electronically to the submitter's email address, from which the submitter can read and review the completed patent specification.

It will also be appreciated that although the invention as used in the system described above requires an inventor to have access to an internet terminal to submit the invention information over the internet via the website form 100, the invention can also be used with the form being separated from the world wide web—for example, the form may be a stand-alone document such as an electronic word-processing document (which may be submitted to the patent attorney by confidential email, from which the patent attorney may then import the information into a computer database and generate the prototype patent specification as described above), or the form may be completed and submitted physically (egg., as a printed page or pages Which can be faxed or mailed) to the patent attorney, who may pass the form through optical character recognition (such as by scanning it into an OCR computer program) and then import the information into a computer database and generate the prototype patent specification as described above. It will thus be appreciated that the system can be easily adapted for use across a range of different modern technologies.

It will be understood that this approach enables a patent specification, complying with substantially all of the formal requirements for most major patent offices worldwide, to be prepared straightforwardly and efficiently. For example, this approach could be used to produce substantially the same examples of patent specifications as shown in the European Patent Office publication “How to Get a European Patent”. Also, it may be noted that this approach was used to write the present patent application.

It will of course be understood that, although in the above example an application form (form 1/77) was described as being automatically generated based on information submitted by an inventor, the invention may be readily applied to the automatic generation of application forms for other jurisdictions, as desired, by positioning relevant information (based on the same or other relevant submitted by an inventor) on images of those forms.

Finally, it may be noted in conclusion that this approach lends itself readily to use over the internet, whose advantages of speed and automation build upon those of the present invention. It will be understood that the system and method for producing a patent specification and patent application described above, although in no way reducing the advisability of consulting a patent attorney (because the scope of protection provided by the patent is determined solely by the precise wording of the claims, which are one of the patent attorney's particular areas of expertise), provides the following advantages:

Automation of a significant part of the process enables a patent specification and patent application to be prepared in less time, potentially allowing the cost to be reduced and the cycle time for filing to be reduced. Conversely, in view of the limited number of patent attorneys, automation of a significant part of the process enables a patent attorney to concentrate his/her time on those parts of the patent application where he/she can most efficiently apply his/her professional skills and add most value, allowing a greater number of patent applications to be prepared.

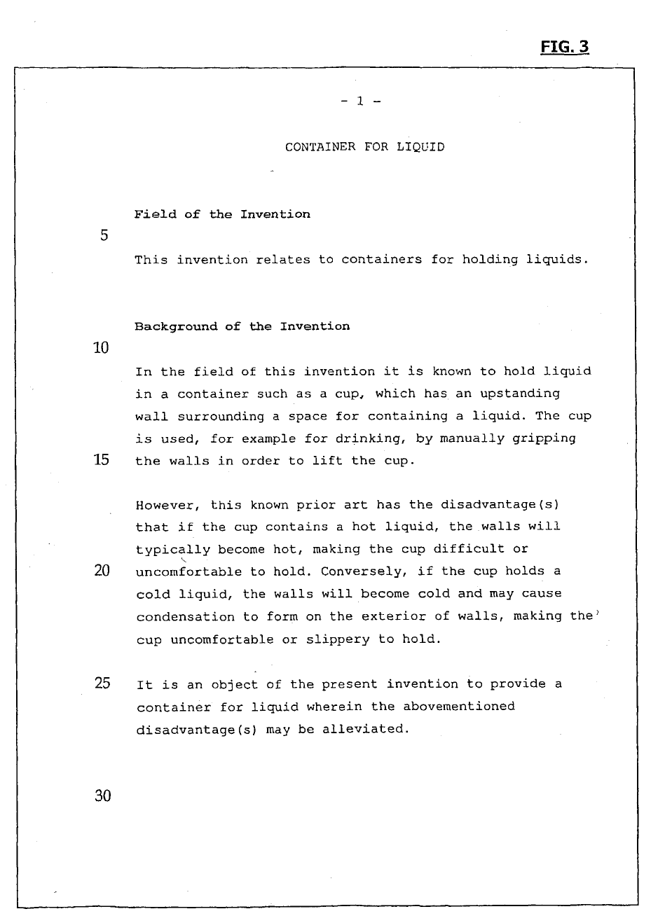

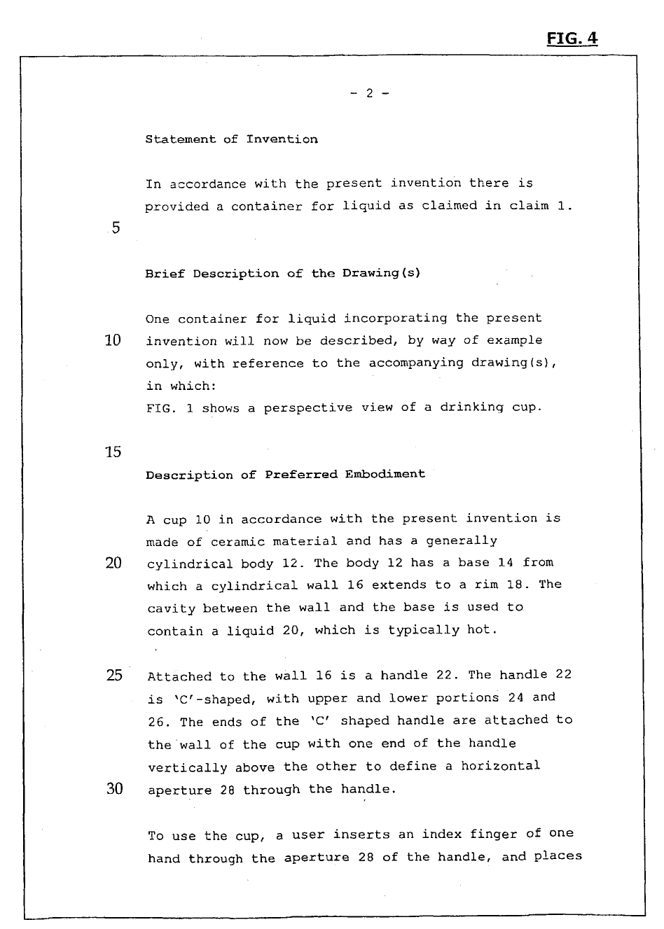

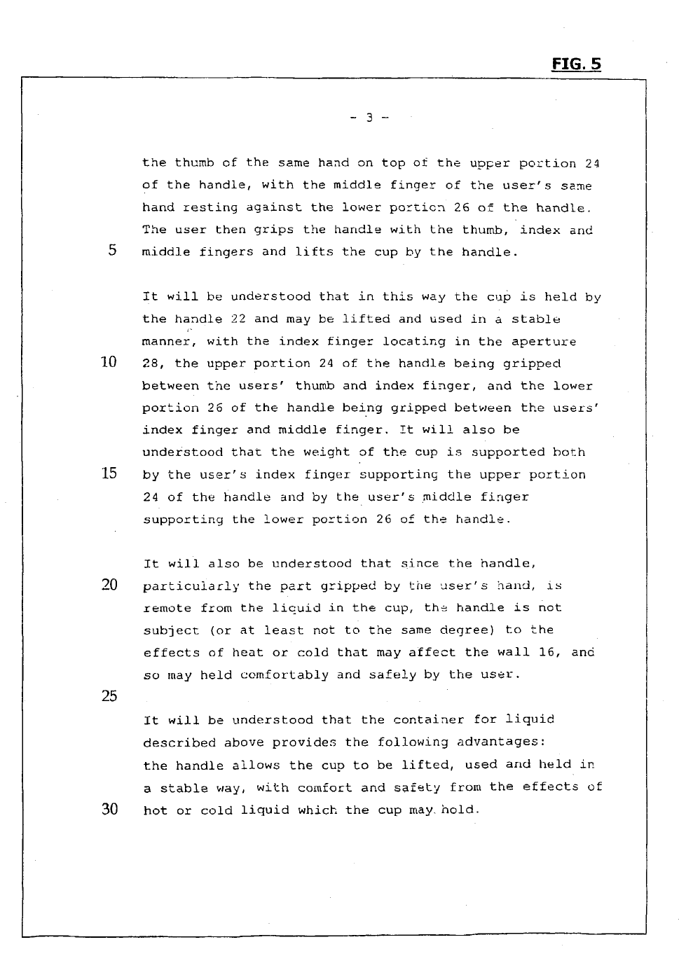

Referring now to FIGS. 3-10, an example of a patent application automatically generated by the present invention is shown. In this example, for the sake of illustration only, the invention is considered to be the provision of a handle on a cup (where the prior art is considered to be a handle-less cup).

The following information is entered into the various website form fields 110-180 and 210-240 as follows:

in form field 110 there is entered

“CONTAINER FOR LIQUID”;

in form field 120 there is entered

“containers for holding liquids”;

in form field 132 there is entered

“to hold liquid in a container such as a cup, which has an upstanding wall surrounding a space for containing a liquid. The cup is used, for example for drinking, by manually gripping the walls in order to lift the cup.”;

in form field 134 there is entered

“if the cup contains a hot liquid, the walls will typically become hot, making the cup difficult or uncomfortable to hold. Conversely, if the cup holds a cold liquid, the walls will become cold and may cause condensation to form on the exterior of walls, making the cup uncomfortable or slippery to hold.”;

in form field 140 there is entered

“A cup 10 in accordance with the present invention is made of ceramic material and has a generally cylindrical body 12. The body 12 has a base 14 from which a cylindrical wall 16 extends to a rim 18. The cavity between the wall and the base is used to contain a liquid 20, which is typically hot.

Attached to the wall 16 is a handle 22. The handle 22 is ‘C’-shaped, with upper and lower portions 24 and 26. The ends of the ‘C’ shaped handle are attached to the wall of the cup with one end of the handle vertically above the other to define a horizontal aperture 28 through the handle.

To use the cup, a user inserts an index finger of one hand through the aperture 28 of the handle., and places the thumb of the same hand on top of the upper portion 24 of the handle, with the middle finger of the user's same hand resting against the lower portion 26 of the handle. The user then grips the handle with the thumb, index and middle fingers and lifts the cup by the handle.

It will be understood that in this way the cup is held by the handle 22 and may be lifted and used in a stable manner, with the index finger locating in the aperture 28, the upper portion 24 of the handle being gripped between the users' thumb and index finger, and the lower portion 26 of the handle being gripped between the users' index finger and middle finger. It will also be understood that the weight of the cup is supported both by the user's index finger supporting the upper portion 24 of the handle and by the user's middle finger supporting the lower portion 26 of the handle.

It will also be understood that since the handle, particularly the part gripped by the user's hand, is remote from the liquid in the cup, the handle is not subject (or at least not to the same degree) to the effects of heat or cold that may affect the wall 16, and so may held comfortably and safely by the user.”;

in form field 150 there is entered

“the handle allows the cup to be lifted, used and held in a stable way, with comfort and safety from the effects of hot or cold liquid which the cup may hold”;

in form field 160 there is entered

“a body for containing liquid; and a handle, attached to the body, by which a user may lift the container”;

in form field 170 there is entered

“the handle has an aperture through which the user's index finger may be located, an upper portion on which the user's thumb may rest, and a lower portion on which the user's middle finger may rest”;

in form field 180 there is entered

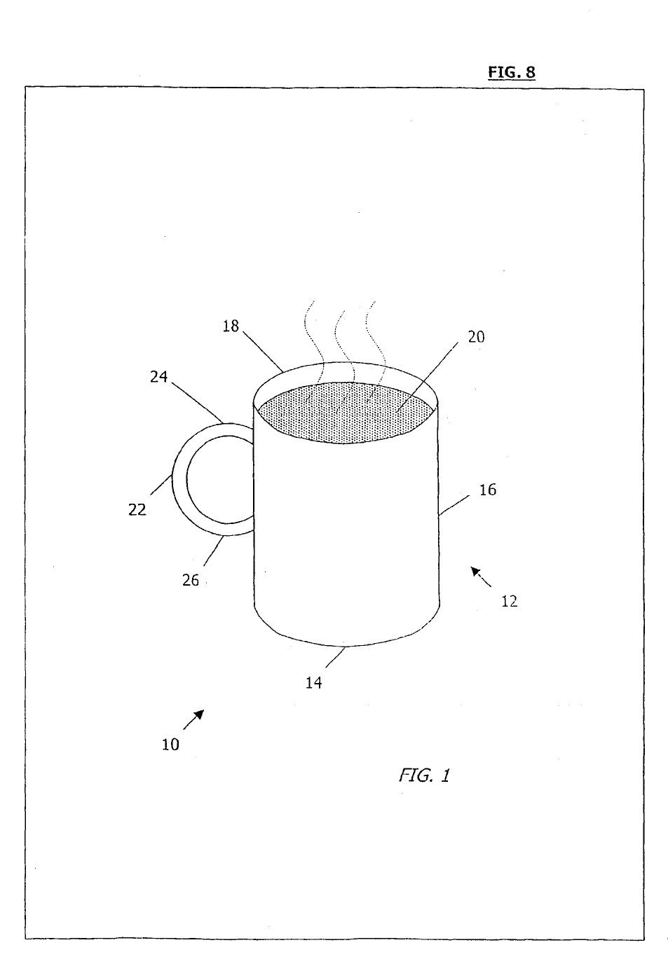

a link to a file containing the image shown in FIG. 8; and

in form field 210 there is entered the inventor's name, shown for purposes of illustration only as

“Inventor/Applicant's Name

Inventor/Applicant's Address”; and

form fields 220-240 are left intentionally blank.

It will be understood that from this submitted information the patent application as shown in FIGS. 3-10 is produced automatically (with minimal change by a patent attorney), the patent application comprising:

a patent specification shown in FIGS. 3-7 having:

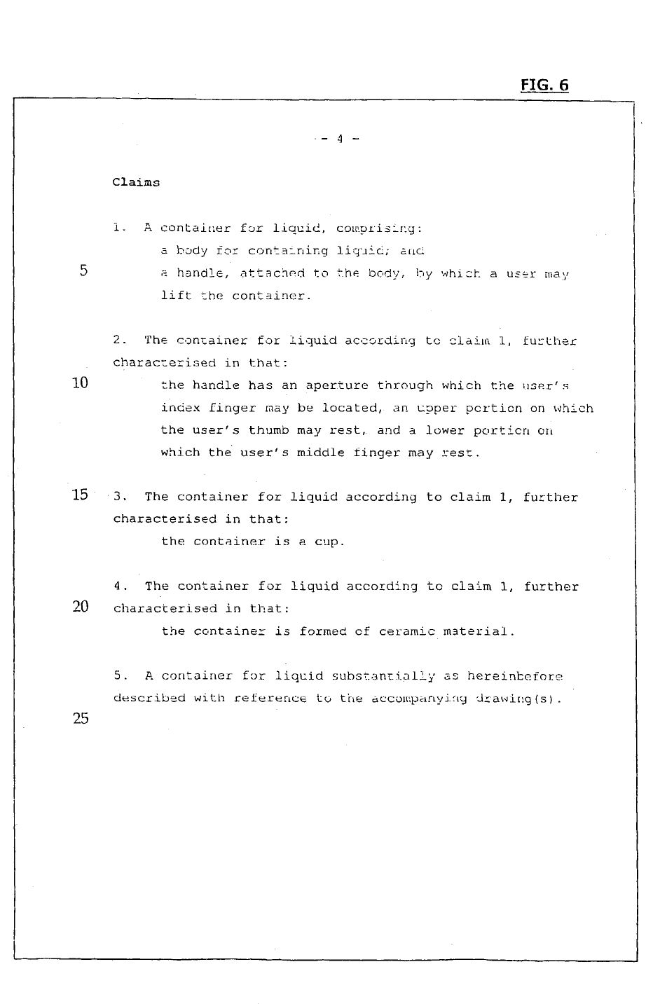

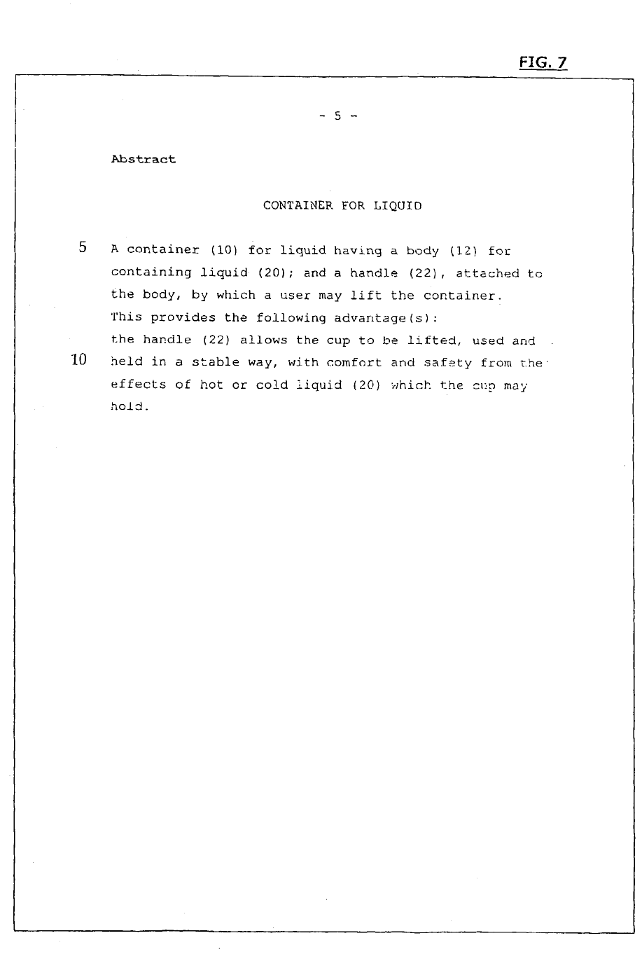

a body as shown in FIGS. 3-5, a claim section as shown in FIG. 6, and an abstract section as shown in FIG. 7;

a drawing as shown in FIG. 8; and

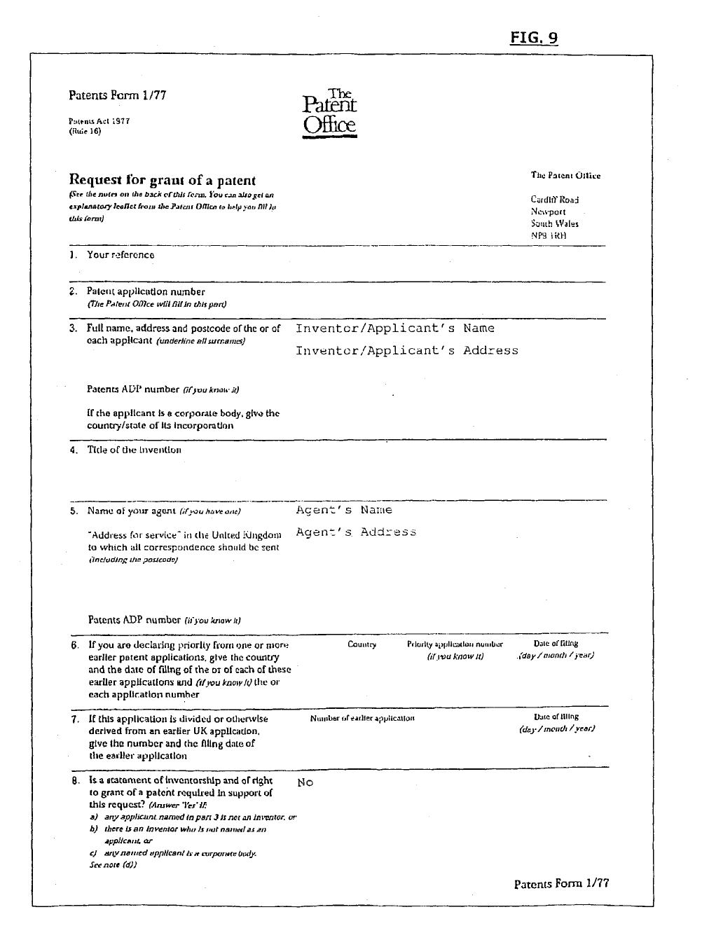

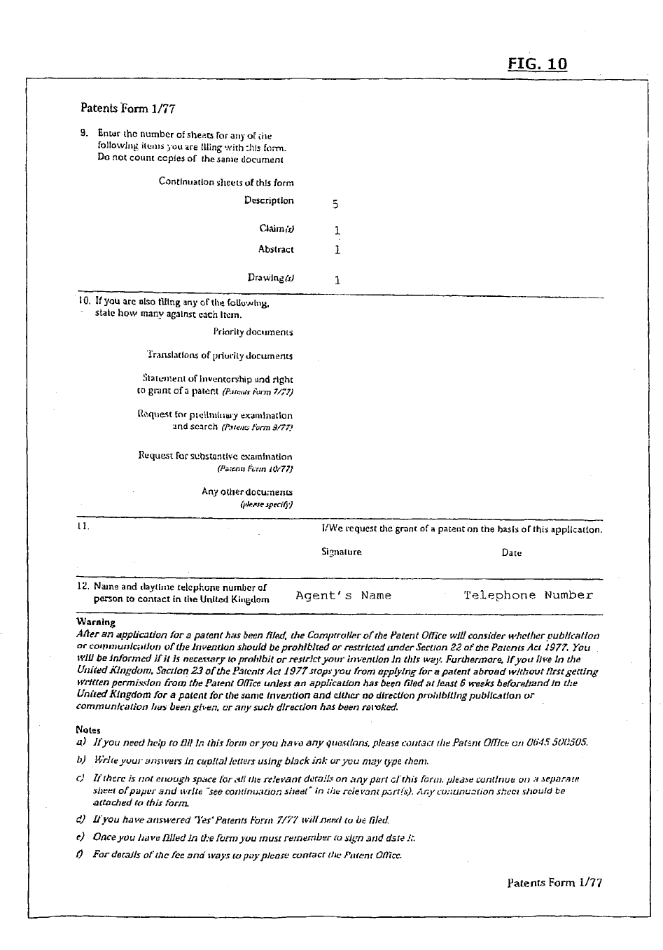

an application form as shown in FIG. 9 and FIG. 10.

1. A system for producing a claim for a patent specification for an invention, comprising:
means for acquiring a title of the invention (110) to produce an acquired title of the invention;
means for acquiring essential features of the invention (160) to produce acquired essential features of the invention; and
means for forming the text of a patent claim from the acquired title of the invention and the acquired essential features of the invention.

2. The system of claim 1 further comprising:
means for acquiring preferred features of the invention (170) to produce acquired preferred features of the invention; and
means for forming from the acquired title of the invention and the acquired preferred features of the invention the text of a further patent claim dependent on the patent claim formed from the acquired essential features of the invention.

3. The system of claim 1 or 2 further comprising:
means for forming the text of a patent abstract from the acquired title of the invention and the acquired essential features of the invention.

4. The system of claim 1, 2 or 3 further comprising:
means for acquiring advantages of the invention (170) to produce acquired advantages of the invention,
wherein the means for forming the text of the patent abstract is arranged to form the text of the patent abstract from the acquired title of the invention, the acquired essential features of the invention and the acquired advantages of the invention.

5. The system of any preceding claim further comprising at least one of:
means for acquiring a detailed description of the invention (140) to produce an acquired detailed description of the invention,
means for acquiring a description of the background of the invention (130) to produce an acquired description of the background of the invention, and
means for acquiring a description of the field of the invention (120) to produce an acquired description of the field of the invention,
and means for forming the text of a body of a patent specification from the at least one of the acquired detailed description of the invention, the acquired description of the background of the invention, and the acquired description of the field of the invention.

6. The system of claim 5 wherein the means for acquiring a description of the background of the invention (130) to produce an acquired description of the background of the invention comprises:
means for acquiring a description of what is known in the field of the invention (132);
means for acquiring a description of disadvantage of what is known in the field of the invention (134).

7. A system for producing a patent specification comprising at least one of A, B, C and D, wherein:
A comprises:
means for acquiring a title of the invention (110) to produce an acquired title of the invention;
means for acquiring essential features of the invention (160) to produce acquired essential features of the invention; and
means for forming the text of a patent claim from the acquired title of the invention and the acquired essential features of the invention,
B comprises:
means for acquiring preferred features of the invention (170) to produce acquired preferred features of the invention; and
means for forming from the acquired preferred features of the invention the text of a dependent patent claim,
C comprises:
means for acquiring a title of the invention (110) to produce an acquired title of the invention;
means for acquiring essential features of the invention (160) to produce acquired essential features of the invention; and
means for forming the text of a patent abstract from the acquired title of the invention and the acquired essential features of the invention, and
D comprises at least one of:
means for acquiring a detailed description of the invention (140) to produce an acquired detailed description of the invention,
means for acquiring a description of the background of the invention (130) to produce an acquired description of the background of the invention, and
means for acquiring a description of the field of the invention (120) to produce an acquired description of the field of the invention,
and means for forming the text of a body of a patent specification from the at least one of the acquired detailed description of the invention, the acquired description of the background of the invention, and the acquired description of the field of the invention.

8. The system of claim 7 wherein the means for forming the text of the patent abstract further comprises means for acquiring advantages of the invention (170) to produce acquired advantages of the invention, and the means for forming the text of the patent abstract is arranged to form the text of the patent abstract from the acquired title of the invention, the acquired essential features of the invention and the acquired advantages of the invention.

9. The system of claim 7 or 8 wherein the means for acquiring a description of the background of the invention (130) to produce an acquired description of the background of the invention comprises: means for acquiring a description of what is known in the field of the invention (132); and means for acquiring a description of disadvantage of what is known in the field of the invention (134).

10. The system of any preceding claim wherein the means for acquiring comprises a field in a form for completion by an inventor.

11. The system of claim 10 wherein the form is provided at a networked computer site remote from an inventor and is arranged for completion remotely by the inventor and for submission over the network.

12. The system of claim 11 wherein the form is an internet form accessible by an internet browser and the network is linked via the internet.

13. The system of claim 12 wherein the form is securely accessible via the internet and wherein the submission over the network is encrypted.

14. The system of claim 13 wherein the form is provided on a secure server, and the secure server is arranged to automatically forward via secure email information submitted in the form.

15. The system of any one of claims 10-14 wherein the means for forming comprise means for receiving submitted form text and for concatenating respective portions thereof with predetermined text.

16. The system of claim 15 wherein the means for forming are automated to concatenate automatically respective portions of submitted form text with predetermined text.

17. The system of claim 16 wherein the means for receiving submitted form text and for concatenating respective portions thereof with predetermined text comprise at least one macro in a computer document.

18. A system for producing a patent specification for an invention, comprising:
means for acquiring information concerning a plurality of different areas of the invention to produce acquired invention information; and
means for automatically forming from the acquired invention information at least a substantial part of the text of the patent specification.

19. A system for producing a document for a patent application, comprising:
means for acquiring information supporting the patent application to produce acquired supporting information;
means for acquiring a patent specification for the patent application; and
means for automatically information from the acquired supporting information and from the acquired patent specification the document for the patent application.

20. The system of claim 19 wherein the means for forming the document for the patent application comprises means for linking the acquired supporting information and the acquired patent specification to the document.

21. The system of claim 19 or 20 wherein the patent specification is produced by the system of any one of claims 1-18, or by the method of any one of claims 30-32 or 41-43.

22. The system of claim 19, 20 or 21 wherein the document is a patent application form.

23. A system for producing a patent application comprising;
means for acquiring information concerning a plurality of different areas of the invention to produce acquired invention information; and
means for acquiring information supporting the patent application to produce acquired supporting information;
means for automatically forming from the acquired invention information and the acquired supporting information at least a substantial part of the text of a patent specification for the patent application and at least a substantial part of an application document for the patent application.

24. A method for producing a claim for a patent specification for an invention, comprising:
acquiring a title of the invention (110) to produce an acquired title of the invention;
acquiring essential features of the invention (160) to produce acquired essential features of the invention; and
forming the text of a patent claim from the acquired title of the invention and the acquired essential features of the invention.

25. The method of claim 24 further comprising:
acquiring preferred features of the invention (170) to produce acquired preferred features of the invention; and
forming from the acquired title of the invention and the acquired preferred features of the invention the text of a further patent claim dependent on the patent claim formed from the acquired essential features of the invention.

26. The method of claim 24 or 25 further comprising:
forming the text of a patent abstract from the acquired title of the invention and the acquired essential features of the invention.

27. The method of claim 26, 27 or 28 further comprising:,
acquiring advantages of the invention (170) to produce acquired advantages of the invention,
wherein the text of the patent abstract is formed from the acquired title of the invention, the acquired essential features of the invention and the acquired advantages of the invention.

28. The method of any one of claims 24-27 claim further comprising at least one of:
acquiring a detailed description of the invention (140) to produce an acquired detailed description of the invention,
acquiring a description of the background of the invention (130) to produce an acquired description of the background of the invention, and
acquiring a description of the field of the invention (120) to produce ail acquired description of the field of the invention,
and forming the text of a body of a patent specification from the at least one of tile acquired detailed description of the invention, the acquired description of the background of the invention and the acquired description of the field of the invention.

29. The method of claim 28 wherein the step of acquiring a description of the background of the invention (130) to produce an acquired description of the background of the invention comprises:
acquiring a description of what is known in the field of the invention (132); and
acquiring a description of disadvantage of what is known in the Field of the invention (134).

30. A method for producing a patent specification comprising at least one of A, B, C and D, wherein:
A comprises:
acquiring a title of the invention (110) to produce an acquired title of the invention;
acquiring essential features of the invention (160) to produce acquired essential features of the inventions and
fording the text of a patent claim from the acquired title of the invention and the acquired essential features of the invention,
B comprises:
acquiring preferred features of the invention (170) to produce acquired preferred features of the invention; and
forming from the acquired preferred features of the invention the text of a dependent patent claim,
C comprises:
acquiring a title of the invention (110) to produce an acquired title of the invention;
acquiring essential features of the invention (160) to produce acquired essential features of the invention; and
forming the text of a patent abstract from the acquired title of the invention and the acquired essential features of the invention, and
D comprises at least one of:
acquiring a detailed description of the invention (140) to produce an acquired detailed description of the invention,
acquiring a description of the background of the invention (130) to produce an acquired description of the background of the invention, and
acquiring a description of the field of the invention (120) to produce an acquired description of the field of the invention,
and forming the text of a body of a patent specification from the at least one of the acquired detailed description of the invention, the acquired description of the background of the invention, and the acquired description of the field of the invention.

31. The method of claim 30 wherein the step of forming the text of the patent abstract further comprises acquiring advantages of the invention (170) to produce acquired advantages of the invention and the text of the patent abstract is formed from the acquired title of the invention, the acquired essential features of the invention and the acquired advantages of the invention.

32. The method of claim 30 or 31 wherein the step of acquiring a description of the background of the invention (130) to produce an acquired description of the background of the invention comprises: acquiring a description of what is known in the field of the invention (132); and acquiring a description of disadvantage of what is known in the field of the invention (134).

33. The method of any one of claims 24-39 wherein the step of acquiring comprises receiving information in a field in a submitted form.

34. The method of claim 33 wherein the form is provided at a networked computer site remote from an inventor and is arranged for completion remotely by the invention and for submission over the network.

35. The method of claim 34 wherein the form is an internet form accessible by an internet browser and the network is linked via the internet.

36. The method of claim 31 wherein the form is securely accessible via the internet and wherein the submission over the network is encrypted.

37. The method of claim 31 wherein the form is provided on a secure server, and the secure server is arranged to automatically forward via secure email information submitted in the form.

38. The method of any one of claims 33-37 wherein the step of forming comprises receiving submitted form text and concatenating respective portions thereof with predetermined text.

39. The method of claim 38 wherein the step of forming concatenates automatically respective portions of submitted form text with predetermined text.

40. The method of claim 39 wherein the step of receiving submitted form text and concatenating respective portions thereof with predetermined text comprises performing at least one macro operation in a computer document.

41. A method for producing a patent specification for an invention, comprising:
acquiring information concerning different areas of the invention to produce acquired invention information; and
automatically forming from the acquired invention information the text of the patent specification.

42. A method for producing a document for a patent application, comprising:
acquiring information supporting the patent application to produce acquired supporting information:
acquiring a patent specification for the patent application; and
automatically forming from the acquired supporting information and from the acquired patent specification the document for the patent application.

43. The method of claim 42 wherein the step of forming the document for the patent application comprises linking the acquired supporting information and the acquired patent specification to the document.

44. The method of claim 42 or 43 wherein the patent specification is produced by the system of any one of claims 1-18, or by the method of any one of claims 30-32 or 41-43.

45. The method of claim 42, 43 or 44 wherein the document is a patent application form.

46. A method for producing a patent application comprising:
acquiring information concerning a plurality of different areas of the invention to produce acquired invention information; and
acquiring information supporting the patent application to produce acquired supporting information;
means for automatically forming from the acquired invention information and the acquired supporting information at least a substantial part of the text of a patent specification for the patent application and at least a substantial part of an application document for the patent application.

47. A patent application for an invention comprising:
a specification;
an application document; and
at least one link between information in the specification and the application document, whereby information is automatically inserted in the application document based on information in the patent specification.

48. A computer program element comprising computer program code means for performing substantially the method of any one of claims 24-46.

49. The computer program element of claim 48 comprising a computer database document.

50. The computer program element of claim 48 or 49 comprising a computer word processing document.

51. The computer program product of claim 48, embodied on a computer readable medium.
